(19) United States
(12) Patent Application Publication
(10) Pub. No.: US 2005/0025240 A1
(43) Pub. Date: Feb. 3, 2005

(54) METHOD FOR PERFORMING PREDICTIVE PICTURE DECODING

(76) Inventors: Hui-Hua Kuo, Tai-Nan City (TW); Gong-Sheng Lin, Tai-Chung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,725

(22) Filed: Jul. 30, 2004

(30) Foreign Application Priority Data
Jul. 30, 2003 (TW) 092120904

(51) Int. Cl. H04N 7/12

(52) U.S. Cl. 375/240.12; 375/240.24

(57) ABSTRACT

A predictive decoding method includes (a) storing a plurality of first vertical predictors of a first block into a storing column of a first memory device, and storing a plurality of first horizontal predictors of a second block into a storing row of the first memory device; (b) performing a prediction operation for generating a plurality of target vertical predictors and a plurality of target vertical predictors of a target block according to the first vertical predictors and the first horizontal predictors, wherein the target block is adjacent to the first and second blocks, and the first and target blocks are located at the same row; and (c) updating the storing column of the first memory device by the target vertical predictors, and updating the storing row of the first memory device by the target horizontal predictors.

### BACKGROUND OF INVENTION

The present invention relates to a method for performing predictive picture decoding, and more specifically, to a method for accessing a plurality of prediction units of a picture in a memory device.

In 1988, the Motion Picture Experts Group (MPEG) was established. MPEG is an International Standard Organization (ISO) work group, which established digital video and audio compression standards. These standards are now being widely used in the industry. Since its establishment in 1988, MPEG has published several important standards.

MPEG-2 and MPEG-4 are two outstanding video compression standards. FIG. 1 illustrates a portion of the MPEG-4 video decoder. The decoder 10 in FIG. 1 includes a variable length decoder 12, an inverse scanner 14, an inverse DC/AC prediction module 16, an inverse quantization unit 18, an inverse DCT 20 and a motion compensation unit 22. The variable length decoder 12 performs variable length decoding on the input compressed video bitstream. The inverse scanner 14 performs inverse scanning and converts the one-dimensional array into a two-dimensional array. The inverse DC/AC prediction module 16 will be described later. The inverse quantization unit 18 receives the two-dimensional array and produce frequency domain DCT coefficients. Then, the inverse DCT converter 20 receives the DCT coefficients, produces many non-zero outputs, and converts frequency domain signals to spatial domain signals. Finally the motion compensation unit 22 applies motion compensation to the received data.

The inverse DC/AC prediction module 16 is one of the major technical features of the MPEG-4 decoder 10. FIG. 2 is a diagram showing operation of the inverse DC/AC prediction module 16 according to the related art. FIG. 2 follows the structure in FIG. 1 to explain the two-dimensional array produced by the inverse scanner 14, which will go through a prediction operation in the inverse DC/AC prediction module 16, and the pixel coefficients for the whole picture will further be decoded on the two-dimensional space. In the process in the inverse DC/AC prediction module 16, the whole picture is divided into a plurality of 8*8 pixel sized blocks. The pixel coefficient of the next newly decoded block is produced by sending partial pixel coefficients of the block which was decoded previously from the prediction selection unit 24 into the inverse DC/AC prediction module 16, combined with the differential value calculated by the variable length decoder 12. For an explanation of the operation of the inversion DC/AC prediction module 16 and prediction selection unit 24 on the picture in FIG. 2, please refer to FIG. 3. FIG. 3 is a diagram illustrating the process of a macro-block 32 in a picture 30 in the above-mentioned process. In the MPEG standard to compress video, the basic processing unit is an 8*8 pixel sized block. A macro-block 32 contains four blocks, and therefore includes 16*16 pixels. MPEG video compression standard uses luminance (Y) and chrominance (Cr, Cb) to represent color. In this example, the macro-block refers to the luminance macro-block. Therefore, if the chrominance data is sampled at half the sample rate of the luminance data along a horizontal direction and a vertical direction, original 16×16 pixels are sampled and the sampled luminance and chrominance data are encoded to generate one luminance macro-block (Y) having luminance information corresponding to the 16×16 pixels and two chrominance blocks (Cr and Cb) each having chrominance information corresponding to half the 16×16 pixels.

Please refer to FIG. 3. The macro-block 32 includes a first block B, a second block C, a third block A and a fourth block X that is to be decoded. To decode the fourth block X, a plurality of predictors will be defined in the neighboring blocks (the first block B, the second block C and the third block A). The plurality of predictors can be classified as DC coefficients and AC coefficients according to the spatial configuration in each block. As shown in FIG. 3, the first block B, the second block C and the third block A each contain a DC coefficient respectively denoted as DC_{B}, DC_{C}, DC_{A} (the shaded squares in the FIG.). As for the fourth block X, in the current prediction operation, the second block C contains a plurality (seven) other AC coefficients: AC_{C} (In two-dimensional representation: AC_{C}[0][n], n is an integer from 1 to 7). In the same manner, the third block A contains a plurality (seven) other AC coefficients: AC_{A} (In two-dimensional representation: AC_{A}[n][0], n is an integer from 1 to 7). Since there are two possible sources for some of the pixel coefficients in the fourth block X, from the upper second block C or from the third block A on the left, to determine if the source of the pixel coefficient in fourth block X is the predictor in the second block C or the third block A, a DCAC direction vector must be determined from the following equation:
|DC_{A}−DC_{B}|<|DC_{B}−DC_{C}| Equation (1)

If Equation (1) holds, then the prediction selection unit 24 in FIG. 2 will determine that the partial pixel coefficients in the fourth block X are from the second block C, and will decide a first DCAC direction vector M1. On the contrary, if Equ.1 does not hold, then the partial pixel coefficients in the fourth block X will be determined to come from the third block A and decides a second DCAC direction vector M2. After deciding the source for the predictors and the DCAC direction vector, the inverse AC/DC prediction module 16 in FIG. 2 will add a DC differential value to the DC coefficient of the source block and set this value to be the DC coefficient (DC_{X}) of the fourth block X, which is shown in FIG. 3 as the first pixel coefficient for the fourth block X; then the prediction selection unit 24 in FIG. 2 will send the AC coefficient of the predictor from the source block to the inverse DC/AC prediction module 16, adding an AC differential value to the AC coefficient and then setting the value to be the AC coefficient to the fourth block X. The AC coefficient is at the first access row or the first access column in the fourth block X. For example, if the source is the upper second block C, the inverse DC/AC prediction module 16 will add the DC and AC differential value calculated from the variable length decoder separately to DC_{C} and AC_{C} of the second block C, then set the result to be the pixel coefficient of the first access row (33) in the fourth block X and sequentially decode the whole fourth block. In the same manner, if the source is the third block A on the left, the inverse DC/AC prediction module 16 will add the DC and AC differential value calculated from the variable length decoder 12 separately to DC_{A} and AC_{A} of the third block A, then set the result to be the pixel coefficient of the first access column (35) in the fourth block X and sequentially decode the whole fourth block.

It can be known from the above that the MPEG-4 compression standard derives the partial pixel coefficients for the block to be decoded from the predictors in the spatially neighboring decoded block. For the whole picture 30, sequentially processing each block according to the above-mentioned method will produce the pixel coefficients for the whole picture. Since in the process of decoding, predictors are decided continuously for the block to be decoded, such that the system (the decoder 10 shown in FIG. 1 and FIG. 2) must be equipped with at least one memory device to store the plurality of predictors. To derive a complete process of prediction operation, the example in FIG. 4 will describe the decoding of a macro-block 42 and observe the number of predictors to be stored in the process. Please refer to FIG. 4. FIG. 4 is a diagram of an embodiment according to the related art. It is slightly differently defined comparing to the embodiment in FIG. 3. This embodiment contains a first block X, a second block Y, a third block X′ and a fourth block Y′ which compose a macro-block 42 to be decoded. Surrounding these 4 blocks are a reference block B, a first adjacent block A, a second adjacent block C, a third adjacent block C′ and a fourth adjacent block A′. Please refer to the structure in FIG. 2. Following the method in the embodiment in FIG. 3, which produces the data for the block to be decoded from the upper and left adjacent blocks, when processing the first block X, a predictor from the upper left reference block B (DC_{B}), eight predictors from the first adjacent block A on the left (one DC_{A} and seven AC_{A}[0][1-7]), and eight predictors from the second adjacent block C on the top (one DC_{C} and seven AC_{C}[1-7][0]) must be provided. The prediction selection unit 24 in FIG. 2 will then determine where the predictor comes from based on DC_{B}, DC_{C} and DC_{A}, and send the rest of the AC coefficients to the inverse DC/AC prediction module 16 in FIG. 2, which will then be combined with the differential value from the variable length decoder 12 to produce the pixel coefficient for the first block X. This means that to decode the first block X, the system has to be equipped with a memory device that has a storage size large enough to store 17 (17=1+8+8) predictors. After the first block X has completed encoding, before processing the second block Y, since the second block Y is adjacent to the first Block X and the third adjacent block C′, the left most column of the first block X has to be set as the predictor and then the DC_{C} of the second adjacent block C, DC_{X} and AC_{X}[1-7][0] of the first block X and DC_{C′} and AC_{C′}[0][1-7] of third adjacent block C′ will be used to decide the partial pixel coefficients for the second block Y. In the same manner, DC_{A} of the first adjacent block A, DC_{X} and AC_{X}[0][1-7] of the first block X and DC_{A′} and AC_{A′}[1-7][0] of the fourth adjacent block A′ can decide the partial pixel coefficients for the third block X′. DC_{X} of the first block X, DC_{Y} and AC_{Y}[0][1-7] of the second block Y and DC_{X′} and AC_{X′}[1-7][0] of the third block X′ can decide the partial pixel coefficients for the fourth block Y′.

For each macro-block 42 (including one luminance macro-block 32(16×16 pixel), one Cb chrominance block (8×8 pixel) and one Cr chrominance block (8×8 pixel)), the above prediction operation and decoding process can be concluded as shown in FIG. 5, which is a flowchart of an embodiment according to the related art.

Step 100: Start;

Step 101: When processing any block in the macro-block (such as a first block X in FIG. 4), determine if there are any predictors to be processed by the prediction operation. (For example, for the first block X in FIG. 4, the required predictor includes predictor DC_{B} from the reference block B, DC_{A} and AC_{A}[0][1-7] from the first adjacent block A, and DC_{C} and AC_{C}[1-7][0] from the second adjacent block C.) If they exist, proceed to step 103, else proceed to step 102;

Step 102: Configure the predictors required to decode the block in a predefined way. If the DC coefficient being configured is a fixed value, then the required AC coefficient is 0. Proceed to step 104 after the configuration;

Step 103: Determine and confirm the source of the predictor and a corresponding DCAC direction vector and produce the required predictor to decode the block. In the actual implementation, the predictor can be retrieved from the memory device in the system for storing predictors.

Proceed to step 104;

Step 104: Produce the DC coefficient for the block to be decoded by adding one DC coefficient from a plurality of predictors to a DC differential value calculated by the variable length decoder; then produce the AC coefficient for the block to be decoded by adding one AC coefficient from a plurality of predictors to an AC differential value calculated by the variable length decoder and put the result into the first access row and the first access column of the block to be decoded;

Step 105: Use a counter and add one to the value (integer) in the counter;

Step 106: Determine if the block counter value in the counter is greater than four. If not, go back to step 101 and continue processing the other blocks in this macro-block. If the block counter value in the counter is greater than four, this shows that the four blocks in the current macro-block have all been processed, and proceed to step 107;

Step 107: Execute the prediction operation and decoding procedure over the 8×8 pixel sized Cb chrominance block and the 8×8 pixel sized Cr chrominance block; and

Step 108: End the prediction operation and decoding procedure in the current macro-block and jump to the next macro-block.

Parts of the above-mentioned related art were specified in the MPEG-4 video compression standard and related methods and structures were publicized in U.S. Pat. No. 6,005,622, “Video coder providing implicit or explicit prediction for picture coding and intra coding of video” by Haskell et al, which is hereby incorporated by reference. Please note that in the related art described in FIG. 4, the predictors have to be produced continuously for use with the block to be decoded during the prediction operation and decoding process, the system has to be equipped with at least one memory device to store a plurality of predictors. According to the embodiment described in FIG. 4, overall in any block in each macro-block, the pixel coefficient in the left most column and the top most row will be decided as predictors; to decode such a macro-block, the system must be configured with a memory device with storage size with at least the size of 17*6 (four Y blocks, one Cb block and one Cr block) predictors. Following the conclusion, to decode all pixel coefficients in a picture over the two-dimensional space, the number of predictor access is formidable. For example, in a 720×480 pixel picture, there are approximately 45*30*17*6 predictors to be decided. This means that the memory device in the system must be large enough to hold the vast number of predictors. But in a technology according to the related art that is based on software to process the decoding procedure (such as disclosed in U.S. Pat. No. 6,005,622), memory size was not so critical. Yet in the present industrial trend to integrate a video codec in a single hardware unit, such huge amount of memory will lead to very high cost for an on-chip configuration in the system.

### SUMMARY OF INVENTION

It is therefore one of the objectives of the invention to provide a method for accessing a plurality of predictors of a picture using less memory to solve the above-mentioned problems.

According to an embodiment of the present invention, a predictive decoding method for decoding a picture to generate a plurality of predictors of a plurality of blocks within the picture is disclosed. The predictive decoding method comprises (a) storing a plurality of first vertical predictors of a first block into a storing column of a first memory device, and storing a plurality of first horizontal predictors of a second block into a storing row of the first memory device; (b) performing a prediction operation for generating a plurality of target vertical predictors and a plurality of target vertical predictors of a first target block according to the first vertical predictors and the first horizontal predictors, wherein the first target block is adjacent to the first and second blocks, and the first block and the first target block are located at the same row; and (c) updating the storing column of the first memory device by the target vertical predictors, and updating the storing row of the first memory device by the target horizontal predictors.

In addition, a method for storing a plurality of predictors of a macro-block into a first memory device and a second memory device is disclosed according to an embodiment of the present invention. The macro-block comprises a first block, a second block, a third block, and a fourth block. The method comprises (a) generating a plurality of predictors of the first block according to a first adjacent block and a second adjacent block; (b) after proceeding with step(a), storing the predictors of the first block into the first memory device; (c) after proceeding with step(b), generating a plurality of predictors of the second block according to a third adjacent block and the first block; (d) after proceeding with step(c), storing the predictors of the second block into the first memory device; (e) after proceeding with step(d), generating a plurality of predictors of the third block according to a fourth adjacent block and the first block; (f) after proceeding with step(e), storing the predictors of the third block into the first memory device and the second memory device; (g) after proceeding with step(f), generating a plurality of predictors of the fourth block according to the second block and the third block; and (h) after proceeding with step(g), storing the predictors of the fourth block into the first memory device and the second memory device.

According to the embodiment, the picture could be a frame, a top field, or a bottom field, as defined in the MPEG standard. For progressive video, a picture is identical to a frame, while for interlaced video, a picture can refer to a frame, or the top field or the bottom field of the frame depending on the context.

These and other objectives of the invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a partial functional block diagram of a related art decoder.

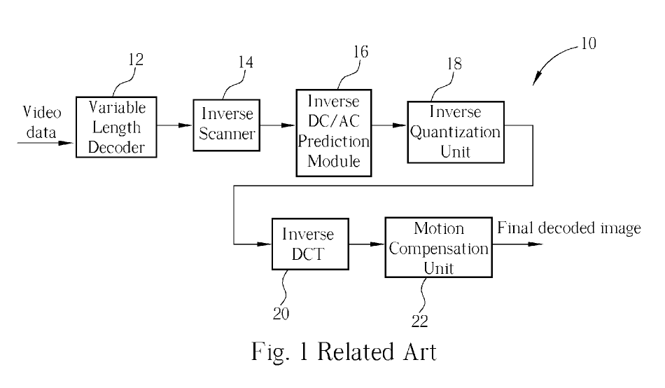

FIG. 2 is a diagram of an embodiment in FIG. 1.

FIG. 3 is a diagram illustrating the execution of predictive decoding on a macro-block in a picture according to the related art.

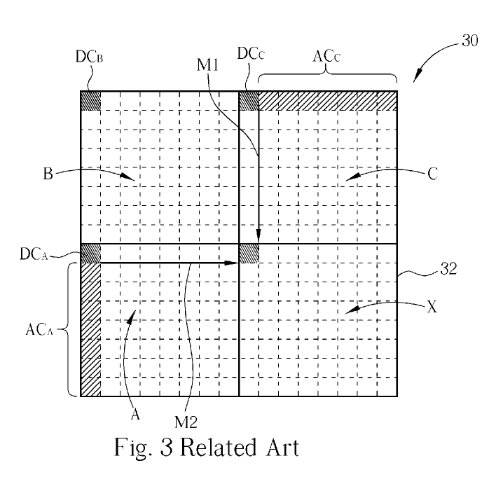

FIG. 4 is a diagram of an embodiment according to the related art.

FIG. 5 is a flowchart of an embodiment according to the related art.

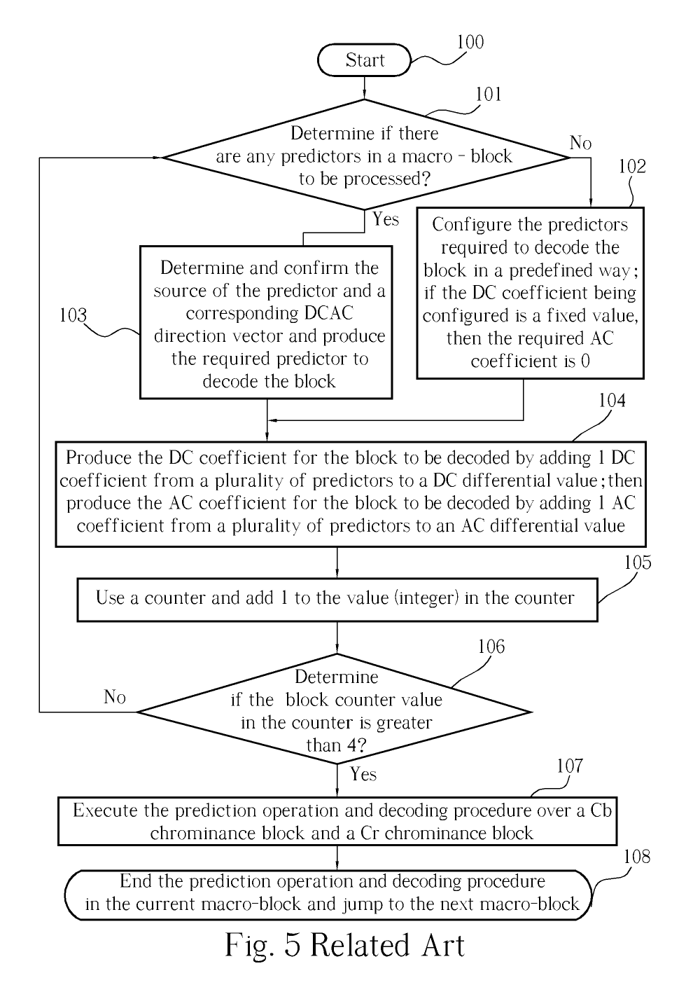

FIG. 6 is a spatial allocation diagram of a picture.

FIG. 7 is a diagram of an embodiment according to the invention.

FIG. 8 is a flowchart of a detailed embodiment according to the invention.

FIG. 9 is a flowchart of another embodiment in FIG. 8.

FIG. 10 is a table illustrating the content changes of the access row, the access column and the additional memory cell in the memory device shown in FIG. 7.

### DETAILED DESCRIPTION

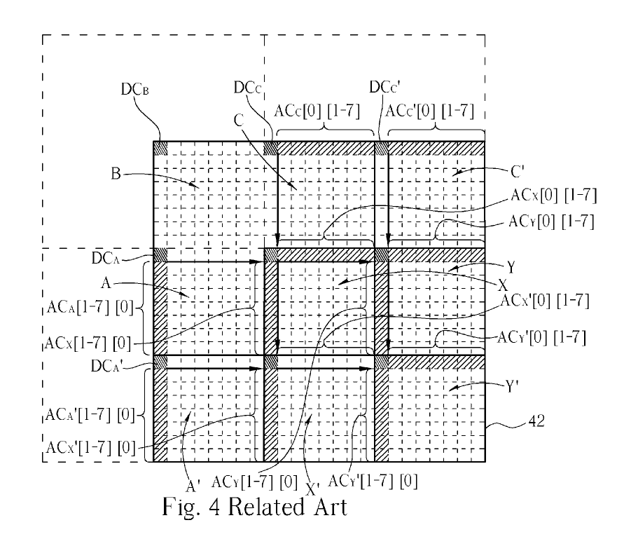

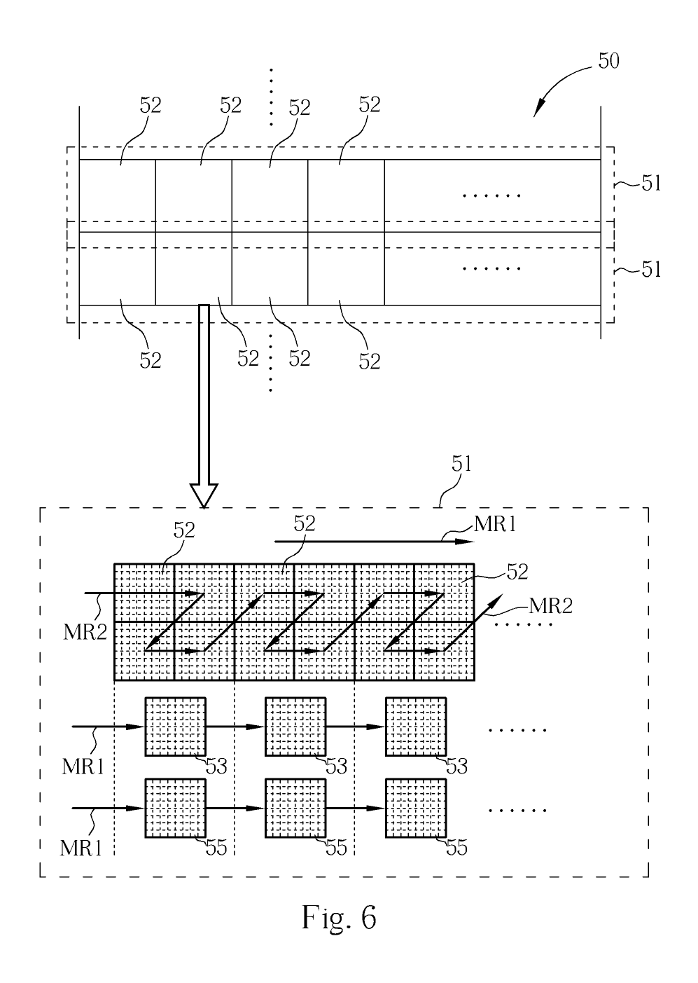

According to the embodiment, the video bistream includes a plurality of pictures, and the picture could be either a frame, a top field, or a bottom field as defined in the MPEG standard. The picture is divided into a plurality of macro-blocks 52 each having 16*16 pixels, and each macro-block 52 is regarded as a processing unit. FIG. 6 is a spatial allocation diagram of a picture. The picture 50 includes a plurality of macro-block rows 51, where each macro-block row 51 includes a plurality of macro-blocks 52 and every macro-block 52 includes four 8*8 pixel sized blocks. For example, for a 720×480 pixel sized picture 50, there are thirty macro-block rows 51, where every macro-block row 51 includes fourty-five macro-blocks 52. Also, the arrow MR1 in FIG. 6 indicates that the order for processing the macro-blocks 52 in a macro-block row 51 is from the left to the right. According to the embodiment shown in FIG. 4, the macro-block 52 is a luminance macro-block. If the chrominance data is sampled at half the sample rate of the luminance data along the horizontal and vertical directions, two 8×8 pixel sized chrominance blocks (Cr and Cb) 53, 55 corresponding to a macro-block 52 are processed before a following 16×16 pixel sized macro-block 52 is decoded.

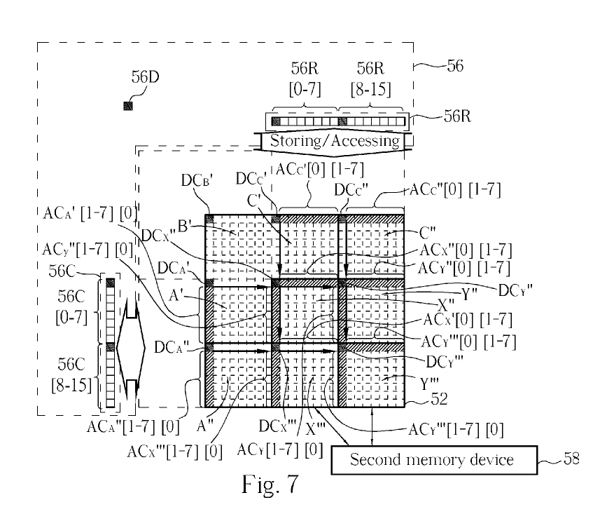

FIG. 7 illustrates an embodiment of the invention. The diagram describes the technical feature of the invention, which utilizes a memory device for accessing the predictors to reduce the amount of storage space needed for related memory devices. Similar to the definition in the prior embodiment example in FIG. 4, the macro block 52 to be decoded in this embodiment includes a first block X″, a second block Y″, a third block X′″, and a fourth block Y′″. Surrounding these four blocks are a reference block B′, a first adjacent block A′, a second adjacent block C′, a third adjacent block C″ and a fourth adjacent block A″. Please note that in FIG. 7, a memory device 56 having an access column 56C and an access row 56R for storing the predictors produced during the prediction decoding procedure is shown. For simplicity, each memory cell in the memory device 56, such as each block in the access column 56C and the access row 56R shown in FIG. 7, is capable of storing one predictor. According to the MPEG-4 video compression standard rules, when processing the block to be decoded, the data is derived from predictors in the adjacent blocks. Please refer to FIG. 7, when processing the first block X″, the system will have to provide one predictor (DC_{B′}) from the reference block B′ on the upper left, eight predictors (one DC_{A′} and seven AC_{A′}[1-7][0]) from the first adjacent block A′ on the left side and eight predictors (one DC_{C′} and seven AC_{C′}[0][1-7]) from the second adjacent block C′ on the upper side.

In this embodiment, we divide the predictors according to their spatial positions into three categories: vertical predictors, horizontal predictors and diagonal predictors. For example, eight predictors at the same column in the first adjacent block A′ (including AC_{A}′[1-7][0], and DC_{A}′) are regarded as vertical predictors. Eight predictors at the same row in the second adjacent block C′ (including AC_{C}′[0][1-7] and DC_{C}′) are regarded as horizontal predictors. The predictor DC_{B′} at the top-left corner in the reference block B′ is regarded as a diagonal predictor. In this embodiment, the predictor at the top-left corner of each block is defined to be a diagonal predictor for another block. For instance, the predictor DC_{B′} of the reference block B′ is a diagonal predictor for the first block X″, and the predictor DC_{C′} of the second adjacent block C′ is a diagonal predictor for the second block Y″. In other words, one of the horizontal predictors of one block also functions as a diagonal predictor for another block, and/or one of the vertical predictors of one block also functions as a diagonal predictor for another block. The eight memory cells of the access row 56R (defined as 56R[0-7]) will store the eight horizontal predictors from the second adjacent block C′; the eight memory cells of access column 56C (defined as 56C[0-7]) will store the eight vertical predictors from the first adjacent block A′. There is another memory cell 56D in the memory device 56 reserved to store the diagonal predictor DC_{B′} of the reference block B″.

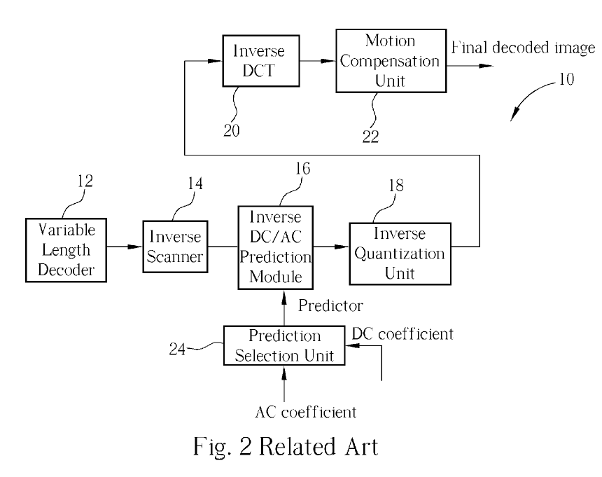

Also refer to FIG. 7. After the system has determined the source of the predictor based on DC_{B′}, DC_{C′}, and DC_{A′,}the rest of the AC coefficients will be combined with the related differential values to produce the pixel coefficient of the first block X″. (Please refer to the embodiment in FIG. 2 according to the related art for the flow of the operation for combining with the differential values.) Next, to complete the rest of the prediction decoding of the macro-block 52, the pixel coefficient of the left most column and top most row of the first block X″ will be set as predictors, and stored into the memory device 56. In this embodiment, the newly decided (horizontal) predictors DC_{X″} and AC_{X″} [0][1-7] of the first block X″ will replace the eight horizontal predictors of the second adjacent block C′ (previously stored in the access row 56R[0-7]) and be stored in the access row 56R[0-7]. In the same manner, the newly decided (vertical) predictors DC_{X″″} and AC_{X″[}1-7][0] of the first block X″ will replace the eight vertical predictors of the first adjacent block A′ (previously stored in the access column 56C[0-7]) and be stored in the access column 56C[0-7]. Thus, there is no additional storage space waste by replacing in the memory device 56. After completing the decoding of first block X″, the second block Y″ will be processed immediately. Since the second block Y″ is adjacent to the first block X″ and the third adjacent block C″, the predictor source will be determined by DC_{C′}, DC_{X″} and DC_{C″}. And then DC_{X″} and AC_{X″}[1-7][0] of the first block X″ and DC_{C″} and AC_{C″}[0][1-7] of third adjacent block C″ will be used to decide the partial pixel coefficients and the predictors of the second block Y″. Afterwards, the newly decided (horizontal) predictors DC_{Y″} and AC_{Y″}[0][1-7] of the second block Y″ will replace the eight horizontal predictors of the third adjacent block C″ (previously stored in the access row 56R[8-15]) and be stored in the access row 56R[8-15]. And the newly decided (vertical) predictors DC_{Y″} and AC_{Y″}[1-7][0] of the second block Y″ will replace the DC_{X″} and AC_{X″}[1-7][0] of the first block X″ which were stored into the access column 56C[0-7] in the previous operation, and be stored into the access column 56C[0-7].

In the same manner, after DC_{A′} of the first adjacent block A′, DC_{X″} and AC_{X″}[0][1-7] of the first block X″ and DC_{A″} and AC_{A″}[1-7][0] of the fourth adjacent block A″ decide the partial pixel coefficients of the third block X′″, the predictor DC_{X′″}, predictors AC_{X′″}[0][1-7] and predictors AC_{X′″}[1-7][0] of the third block X′″ will be decided and the newly decided predictors DC_{X′″} and AC_{X′″}[1-7][0] will replace the eight vertical predictors of the fourth adjacent block A″ which were stored in the access column 56C[8-15] and be stored in the access column 56C[8-15]. And DC_{X″} of the first block X″, DC_{Y″} and AC_{Y″} [0][1-7] of the second block Y′, and DC_{X′″} and AC_{X′″}[1-7][0] of the third block X′″ will decide the partial pixel coefficients of the fourth block Y′″, then the predictor DC_{Y′″} of the fourth block Y′″, the predictors AC_{Y′″}[0][1-7] and the predictors AC_{Y′″[}1-7][0] will be decided and the newly decided predictors DC_{Y′″} and AC_{Y′″}[1-7][0] will replace the DC_{X′″} and AC_{X′″}[1-7][0] of the third block X′″ in the access column 56C[8-15] in the previous operation and be stored in the access column 56C[8-15].

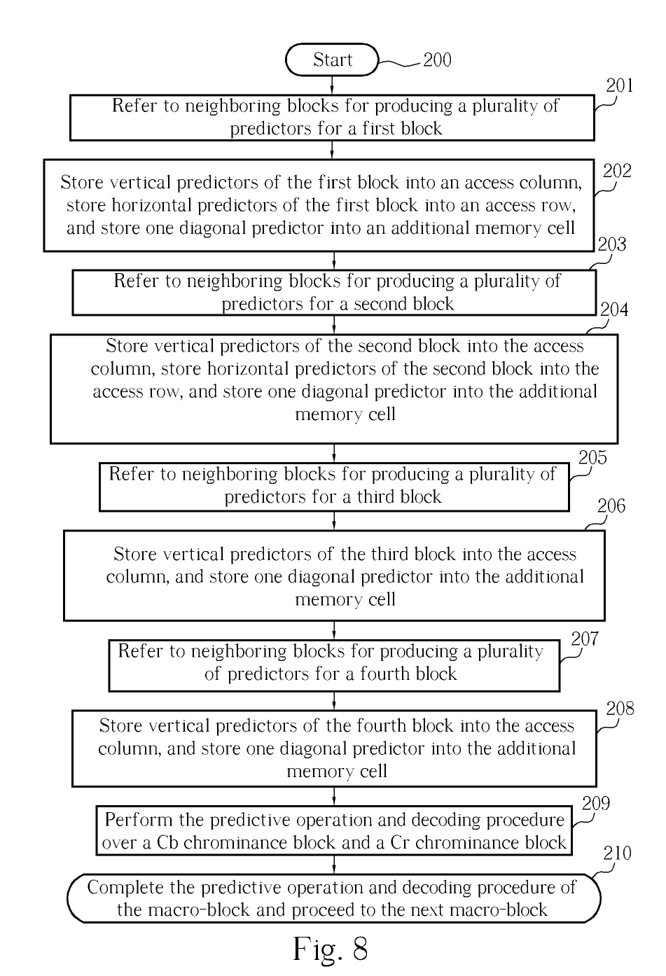

This embodiment stores the vertical predictors, the horizontal predictors and the diagonal predictor into the access column 56C, the access row 56R, and an additional memory cell 56D of the memory device 56, utilizing a swap and replace method to minimized storage space usage in the memory device 56. In an actual implementation, the memory device 56 can be a processing register, or even be an ordinary register if the hardware performance permits. The embodiment accesses a plurality of predictors of a picture 50 using a memory device 56, and the procedure of the predictive decoding is illustrated in the following eight steps, as shown in FIG. 8 according to the embodiment.

Step 200: Start;

Step 201: When processing a first block X″ in a macro-block 52, refer to the neighboring blocks for producing a plurality of predictors for the first block X″, and proceed to step 202. The plurality of predictors include horizontal predictors, vertical predictors and a diagonal predictor. Referring to FIG. 7, the first block is located in the upper left of the macro-block 52. The neighboring blocks include a reference block B′ located on the upper-left side to the first block X″, a first adjacent block A′ located on the left to the first block X″, and a second adjacent block C′ located on the upper side to the first block X″;

Step 202: Store the vertical predictors into the access column 56C[0-7], store the horizontal predictors into the access row 56R[0-7], and store one diagonal predictor into the above-mentioned additional memory cell 56D. Proceed to step 203. The newly calculated horizontal predictors of the first block X″ will replace the horizontal predictors of the second adjacent block C′ previously stored in the access row 56R[0-7]. The newly calculated vertical predictors of the first block X″ will replace the vertical predictors of the second adjacent block C′ previously stored in the access column 56C[0-7]. The diagonal predictor DC_{C′} for the second block Y″ will replace the diagonal predictor DC_{B′} for the first block X″ previously stored in the additional memory cell 56D;

Step 203: When processing a second block Y″ in a macro-block 52, refer to the neighboring blocks for producing a plurality of predictors for the second block Y″, and proceed to step 204. The plurality of predictors include horizontal predictors, vertical predictors and a diagonal predictor. Referring to FIG. 7, the second block is located in the upper right of the macro-block 52. The neighboring blocks include the second neighboring block C′ located on the upper-left side to the second block Y″, the first block X″ located on the left to the second block Y″, and a third adjacent block C″ located on the upper side to the second block Y″;

Step 204: Store the vertical predictors (a total of eight) of the second block Y″ into the access column 56C[0-7], store the horizontal predictors (a total of eight) into the access row 56R[8-15], and store one diagonal predictor into the additional memory cell. Proceed to step 205. The newly calculated horizontal predictors of the second block Y″ will replace the horizontal predictors (a total of eight) of the third adjacent block C″ previously stored in the access row 56R[8-15]. The newly calculated vertical predictors of the second block Y″ will replace the vertical predictors (a total of eight) of the first block X″ previously stored in the access column 56C[0-7] in step 202. The diagonal predictor DC_{A′} for the third block X′″ will replace the diagonal predictor DC_{C′} for the second block Y″ previously stored in the additional memory cell 56D;

Step 205: When processing a third block X′″ in a macro-block 52, refer to the neighboring blocks for producing a plurality of predictors for the third block X′″, and proceed to step 206. The plurality of predictors include vertical predictors and a diagonal predictor. Referring to FIG. 7, the third block is located in the lower left of the macro-block 52. The neighboring blocks include the first adjacent block A′ located on the upper-left side to the third block X′″, a fourth adjacent block A″ located on the left to the first block, and the first block X″ located on the upper side to the third block X′″;

Step 206: Store the vertical predictors into the access column 56C[8-15], and store one diagonal predictor into the additional memory cell. Proceed to step 207. The newly calculated vertical predictors of the third block X′″ will replace the vertical predictors of the fourth adjacent block A″ previously stored in the access column 56C[8-15]. The diagonal predictor DC_{X″} for the fourth block Y′″ will replace the diagonal predictor DC_{A′} for the third block X′″ previously stored in the additional memory cell 56D.

Step 207: When processing a fourth block Y′″ in a macro-block 52, refer to the neighboring blocks for producing a plurality of predictors for the fourth block Y′″ and proceed to step 208. The plurality of predictors include vertical predictors and a diagonal predictor. Referring to FIG. 7, the fourth block is located in the lower right of the macro-block 52. The neighboring blocks include the first block X″ located on the upper-left side to the fourth block Y′″ the third block X″ located on the left to the fourth block Y′″ and the second block Y″ located on the upper side to the fourth block Y′″;

Step 208: Store the vertical predictors to the access column 56C[8-15], and store one diagonal predictor to the additional memory cell 56D. Proceed to step 209. The newly calculated vertical predictors of the fourth block Y′″ will replace the vertical predictors of the third block X′″ previously stored in the access column 56C[8-15]. The diagonal predictor DC_{C″} for a first block of a following macro-block will replace the diagonal predictor DC_{X″} for the fourth block Y′″ previously stored in the additional memory cell 56D.

Step 209: Perform the predictive operation and decoding procedure over an 8×8 pixel sized Cb chrominance block and an 8×8 pixel sized Cr chrominance block; and

Step 210: Complete the predictive operation and decoding procedure of the macro-block 52. Proceed to the next macro-block.

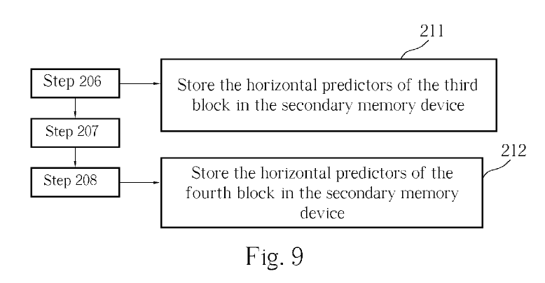

According to the flow diagram in FIG. 8, and referring to the spatial configuration in FIG. 6, the predefined order of the embodiment to process the macro-block 52 can be known (as shown by the arrow MR2). Thus when processing each macro-block 52, the four blocks are processed in a Z shaped order. And after completing this (16×16 pixel sized) luminance macro-block 52, the two corresponding 8×8 pixel sized chrominance blocks (Cr and Cb) will be processed. After completing the processing of a macro-block 52, proceed to the next macro-block 52 in the same macro-block row, from the left to the right (as shown by arrow MR1), thus processing every macro-block in the macro-block row. From the above, it is known that the processing order of the macro-blocks is from the left to the right in a macro-block row 51. Therefore when the system completes processing a macro-block 52, the macro-block 52 located beneath the currently processed macro-block 52 is not processed immediately. Therefore, it is not necessary to save the horizontal predictors (DC_{X′″ and AC}_{X′″}[0][1-7]) of the third block X′″ and the horizontal predictors (DC_{Y′″} and AC_{Y′″}[0][1-7]) of the fourth block Y′″ into the memory device 56 because these horizontal predictors are merely helpful to these macro-blocks 52 that are located beneath the currently processed macro-block 52 and still awaiting to be processed. This is why in FIG. 8, the steps in the flow diagram do not include “The newly calculated horizontal predictors of the third block X′″ will replace the horizontal predictors of the first block X″ previously stored in the access row 56R[0-7]” and/or “The newly calculated horizontal predictors of the fourth block X′″ will replace the horizontal predictors of the second block Y″ previously stored in the access row 56R[8-15]”. In this embodiment, there is another secondary memory device 58 in FIG. 9. The secondary memory device 58 can be implemented by a DRAM, an SRAM or registers to store the horizontal predictors of the third (lower left) and the fourth (lower right) block of every macro-block 52. After all macro-blocks 52 have been completely processed in a macro-block row, the predictors stored in secondary memory device 58 can then be used to execute predictive decoding procedure for the macro-blocks 52 in the next macro-block row. Please refer to FIG. 9, which is the flow diagram for another embodiment of FIG. 8, with additional steps to be performed on the secondary memory device.

Step 211: In step 206 of FIG. 8, store the horizontal predictors of the third block in the secondary memory device.

Step 212: In step 208 of FIG. 8, store the horizontal predictors of the fourth block in the secondary memory device.

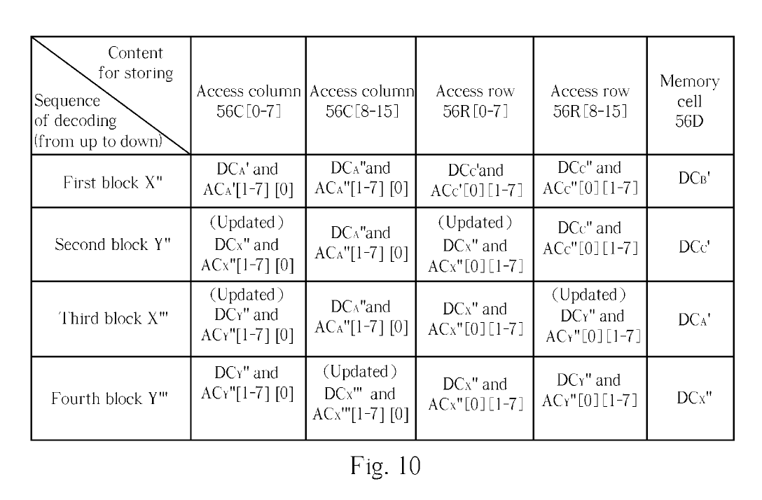

According to the disclosure in the embodiment of FIG. 7, the replacing of the content in the access column 56C[0-7], access column 56C[8-15], access row 56R[0-7] and access row 56R[8-15] is listed in FIG. 10. In the process of prediction operation and decoding, even if predictors are decided continuously for use by the macro-block to be decoded, the embodiment can complete the predictive decoding with far less memory space then the actual number of predictors produced since it divides the memory device into an access row and an access column and swaps and replaces the vertical predictors, horizontal predictors and diagonal predictors, unlike the related art which has to store all predictors. To compare with the related art, during the predictive decoding of a macro-block, the present invention only require a memory device with thirty-three memory cells (calculation based on embodiment in FIG. 7: the access column 56C[0-7], access column 56C[8-15], access row 56R[0-7] and access row 56R[8-15] take up to 4*8=32 memory cells, with 1 additional memory cell for the diagonal predictor). Even with the secondary memory device, a macro-block would need only an additional sixteen memory cells.

In the embodiment, the memory size in the system is greatly reduced. For example for a whole picture (like a 720×480 pixel sized), the size of the memory device 56 reduced is very significant. Not only is the processing register based memory device usage reduced, the secondary memory device storage is also small, so the memory device 56 illustrated in FIG. 7 (and the secondary memory device 58) can be integrated into the system in an on-chip fashion, which reduces costs and continues the trend of integrating all video CODECs in one single chip.

Those skilled in the art will readily observe that numerous modifications and alterations of the device may be made while retaining the teachings of the invention. Accordingly, the above disclosure should be construed as limited only by the metes and bounds of the appended claims.

1. A predictive decoding method for decoding a picture to generate a plurality of predictors of a plurality of blocks corresponding to the picture, the predictive decoding method comprising the steps of:
(a) storing a plurality of first vertical predictors of a first block into a storing column of a first memory device, and storing a plurality of first horizontal predictors of a second block into a storing row of the first memory device;
(b) performing a prediction operation for generating a plurality of target vertical predictors and a plurality of target vertical predictors of a first target block according to the first vertical predictors and the first horizontal predictors, wherein the first target block is adjacent to the first and second blocks, and the first block and the first target block are located at the same row; and
(c) updating the storing column of the first memory device by the target vertical predictors, and updating the storing row of the first memory device by the target horizontal predictors.

2. The predictive decoding method of claim 1 wherein the first and second blocks and the first target block are located within different macro-blocks each comprising a plurality of blocks, the first target block is not located at a bottom row of a corresponding macro-block, and step (c) updates the storing column by the target vertical predictors and updates the storing rows by the target horizontal predictors.

3. The predictive decoding method of claim 2 wherein step (a) further comprises storing a diagonal predictor for the first target block into a memory cell of the first memory device, step (b) generates the target horizontal predictors and the target vertical predictors according to the diagonal predictor, the first vertical predictors, and the first horizontal predictors, and step (c) further comprises updating the memory cell of the first memory device by a diagonal predictor for a second target block being processed after the first target block, wherein the first and second target blocks are located within the same macro-block.

4. The predictive decoding method of claim 1 wherein the first block and the first target block are located within a macro-block comprising a plurality of blocks, the second block is located within another macro-block comprising a plurality of blocks, the first target block is not located at a bottom row of the corresponding macro-block, the first vertical predictors are stored in a first part of the storing column, the first horizontal predictors are stored in a first part of the storing row, and step (c) updates the first part of the storing column by the target vertical predictors and updates a second part of the storing row by the target horizontal predictors.

5. The predictive decoding method of claim 4 wherein step (a) further comprises storing a diagonal predictor for the first target block into a memory cell of the first memory device, step (b) generates the target horizontal predictors and the target vertical predictors according to the diagonal predictor, the first vertical predictors, and the first horizontal predictors, and step (c) further comprises updating the memory cell of the first memory device by a diagonal predictor for a second target block being processed after the first target block, wherein the first and second target blocks are located within the same macro-block.

6. The predictive decoding method of claim 1 wherein the first block is located within a macro-block comprising a plurality of blocks, the second block and the first target block are located within another macro-block comprising a plurality of blocks, the target block is located at a bottom row of the corresponding macro-block, and step (c) updates the storing column by the target vertical predictors without updating the storing row.

7. The predictive decoding method of claim 6 wherein step (a) further comprises storing a diagonal predictor for the first target block into a memory cell of the first memory device, step (b) generates the target horizontal predictors and the target vertical predictors according to the diagonal predictor, the first vertical predictors, and the first horizontal predictors, and step (c) further comprises updating the memory cell of the first memory device by a diagonal predictor for a second target block being processed after the first target block, wherein the first and second target blocks are located within the same macro-block.

8. The predictive decoding method of claim 6 further comprising storing the target horizontal predictors into a second memory device.

9. The predictive decoding method of claim 1 wherein the first and second blocks and the first target block are located within a macro-block comprising a plurality of blocks, the first target block is located at a bottom row of the macro-block, and step (c) updates the storing column by the target vertical predictors without updating the storing row.

10. The predictive decoding method of claim 9 wherein step (a) further comprises storing a diagonal predictor for the first target block into a memory cell of the first memory device, step (b) generates the target horizontal predictors and the target vertical predictors according to the diagonal predictor, the first vertical predictors, and the first horizontal predictors, and step (c) further comprises updating the memory cell of the first memory device by a diagonal predictor for a second target block being processed after the first target block, wherein the first and second target blocks are not located within the same macro-block.

11. The predictive decoding method of claim 9 further comprising storing the target horizontal predictors into a second memory device.

12. The predictive decoding method of claim 1 wherein the picture conforms to an MPEG specification.

13. The predictive decoding method of claim 12 wherein the vertical and horizontal predictors of a block lie in the most left column and top row of the block, and the horizontal predictors and the vertical predictors of the block respectively comprise a DC coefficient and a plurality of AC coefficients.

14. A method for storing a plurality of predictors of a macro-block into a first memory device and a second memory device, the macro-block comprising a first block, a second block, a third block, and a fourth block, the method comprising:
(a) generating a plurality of predictors of the first block according to a first adjacent block and a second adjacent block;
(b) after proceeding with step(a), storing the predictors of the first block into the first memory device;
(c) after proceeding with step(b), generating a plurality of predictors of the second block according to a third adjacent block and the first block;
(d) after proceeding with step(c), storing the predictors of the second block into the first memory device;
(e) after proceeding with step(d), generating a plurality of predictors of the third block according to a fourth adjacent block and the first block;
(f) after proceeding with step(e), storing the predictors of the third block into the first memory device and the second memory device;
(g) after proceeding with step(f), generating a plurality of predictors of the fourth block according to the second block and the third block; and
(h) after proceeding with step(g), storing the predictors of the fourth block into the first memory device and the second memory device.

15. The method of claim 14 wherein a plurality of predictors for each block comprise a plurality of vertical predictors, a plurality of horizontal predictors, and a diagonal predictor, and the method further comprises:
(i) in step(b), storing a plurality of vertical predictors of the first block into a storing column of the first memory device, and storing a plurality of horizontal predictors of the first block into a storing row of the first memory device;
(j) in step(d), storing a plurality of vertical predictors of the second block into the storing column of the first memory device, and storing a plurality of horizontal predictors of the second block into the storing row of the first memory device;
(k) in step (f), storing a plurality of vertical predictors of the third block into the storing column of the first memory device, and storing a plurality of horizontal predictors of the third block into the second memory device; and
(l) in step (h), storing a plurality of vertical predictors of the fourth block into the storing column of the first memory device, and storing a plurality of horizontal predictors of the fourth block into the second memory device.

16. The method of claim 15 wherein in step(j), the vertical predictors of the second block stored into the storing column of the first memory device replace the vertical predictors of the first block initially stored in the storing column, and in step(l), the vertical predictors of the fourth block stored into the storing column of the first memory device replace the vertical predictors of the third block initially stored in the storing column.

17. The method of claim 15 wherein the vertical and horizontal predictors of a block lie in the most left column and top row of the block, and the vertical predictors and the horizontal predictors of the block respectively comprise a plurality of AC coefficients and a DC coefficient.

18. The method of claim 14 wherein the first block is at an upper-left site of the macro-block, the second block is at an upper-right site the macro-block, the third block is at a lower-left site of the macro-block, and the fourth block is at a lower-right site of the macro-block.

19. The method of claim 14 wherein the first adjacent block is at a left side of the first block, the second adjacent block is at an upper side of the first block, the third adjacent block is at an upper side of the second block, and the fourth adjacent block is at a left side of the third block.

20. The method of claim 14 wherein the macro-block conforms to an MPEG specification.
